(19) United States
(12) Patent Application Publication
(10) Pub. No.: US 2015/0254364 A1
(43) Pub. Date: Sep. 10, 2015

(54) ACCESSING A FILE IN A VIRTUAL COMPUTING ENVIRONMENT

(71) Applicant: VMware, Inc., Palo Alto, CA (US)

(72) Inventors: Sudarsan R. PIDURI, Campbell, CA (US); Laurent DELAMARE, Los Altos, CA (US); Swapnil DAINGADE, Sunnyvale, CA (US)

(73) Assignee: VMware, Inc., Palo Alto, CA (US)

(21) Appl. No.: 14/196,141

(22) Filed: Mar. 4, 2014

(51) Int. Cl. G06F 17/30

(52) U.S. Cl. CPC G06F 17/30893

(57) ABSTRACT

In a computer-implemented method for exploring files stored on a virtual disk associated with a virtual machine in a virtual computing environment, at least a virtual disk associated with a virtual machine is displayed in a web user interface. The virtual machine is not powered on. In response to instructions received via the web user interface, the virtual disk is accessed without powering on the virtual machine. One or more files on the virtual disk are presented in the web user interface.

### BACKGROUND

In conventional virtual computing environments, in order for a file to be accessed, the hard disk (where the file resides) is associated with a virtual machine and the virtual machine is powered on. However, powering on a virtual machine to access a file may negatively affect the virtual computing environment. For example, the file to be accessed may have a virus or the associated virtual machine does not include the appropriate patches.

### BRIEF DESCRIPTION OF THE DRAWINGS

The accompanying drawings, which are incorporated in and form a part of this specification, illustrate various embodiments and, together with the Description of Embodiments, serve to explain principles discussed below. The drawings referred to in this brief description of the drawings should not be understood as being drawn to scale unless specifically noted.

FIG. 1 depicts a block diagram of a virtual computing environment, according to various embodiments.

FIG. 2 depicts a block diagram of a virtual computing environment, according to various embodiments.

FIG. 3A depicts a screenshot of a user interface, according to various embodiments.

FIG. 3B depicts a screenshot of a user interface, according to various embodiments.

FIG. 4 depicts a flow diagram for a method for accessing a file located in a virtual computing environment, according to various embodiments.

FIG. 5 depicts a flow diagram for a method for accessing a file located in a virtual computing environment, according to various embodiments.

FIG. 6 depicts a flow diagram for a method for accessing a file located in a virtual computing environment, according to various embodiments.

FIG. 7 depicts a block diagram that illustrates an embodiment of a host computing system.

### DETAILED DESCRIPTION OF CERTAIN EMBODIMENTS

Embodiments described herein are directed towards accessing one or more files located in a virtual computing environment without requiring powering on a virtual machine associated with the one or more files. For instance, a user may utilize a user-interface of a management system (or an API) to view and/or select various files that are associated with one or more virtual machines. Once selected, the file may be accessed without requiring an associated virtual machine to be powered on. In one embodiment, files associated with multiple virtual machines are presented to a user for access without requiring the associated virtual machines to be powered on. A user may perform a search across multiple virtual machines without powering on the virtual machines. The search may also be performed across a plurality of virtual disks, at least one of which is not associated with a virtual machine.

Reference will now be made in detail to various embodiments, examples of which are illustrated in the accompanying drawings. While various embodiments are discussed herein, it will be understood that they are not intended to be limiting. On the contrary, the presented embodiments are intended to cover alternatives, modifications and equivalents, which may be included within the spirit and scope the various embodiments as defined by the appended claims. Furthermore, in this Description of Embodiments, numerous specific details are set forth in order to provide a thorough understanding. However, embodiments may be practiced without one or more of these specific details. In other instances, well known methods, procedures, components, and circuits have not been described in detail as not to unnecessarily obscure aspects of the described embodiments.

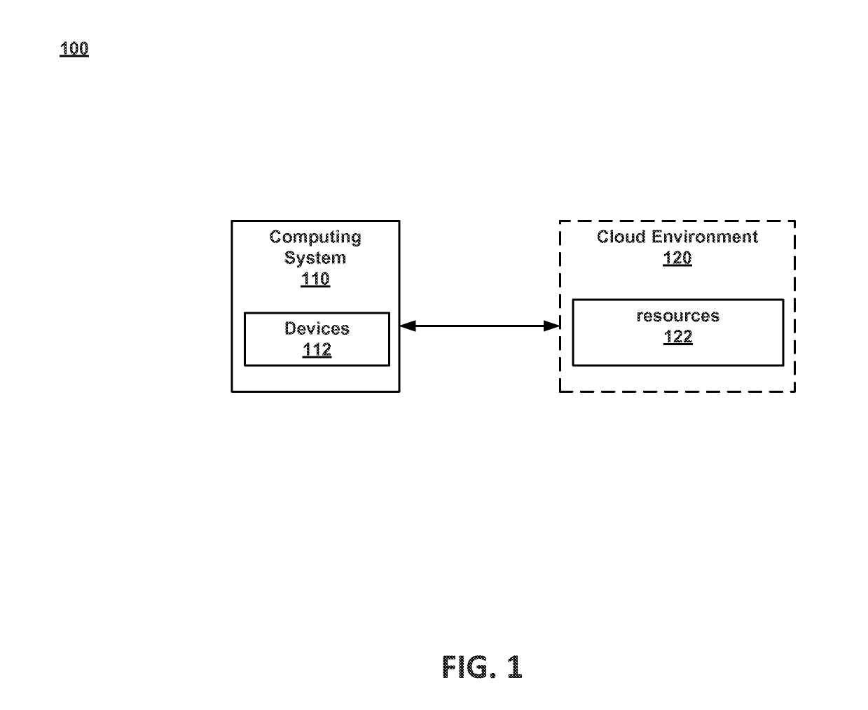

FIG. 1 depicts a block diagram that illustrates virtual computing environment (VCE) 100 (or virtualization infrastructure) that includes computing system 110 and cloud environment 120, according to various embodiments. In general, computing system 110 and cloud environment 120 are communicatively coupled over a network such that computing system 110 may access functionality of cloud environment 120.

As will be described in further detail below, computing system 110 is implemented using cloud environment 120. Also, while implementing the business functionality, computing system 110 might use some of resources 122.

In one embodiment, computing system 110 may be a system (e.g., enterprise system) or network that includes a combination of computer hardware and software. The corporation or enterprise utilizes the combination of hardware and software to organize and run its operations. To do this, system 110 uses resources 122 because system 110 typically does not have dedicated resources that can be given to the cloud environment. For example, an enterprise system may provide various computing resource for various needs such as, but not limited to information technology (IT), security, email, etc.

In various embodiments, computing system 110 includes a plurality of devices 112. The devices are any number of physical and/or virtual machines. For example, in one embodiment, computing system 110 is a corporate computing environment that includes tens of thousands of physical and/or virtual machines. It is understood that a virtual machine is implemented in cloud environment 120 that includes one or some combination of physical computing machines. Cloud environment 120 provides resources 122, such as storage, memory, servers, CPUs, network switches, etc., that are the underlying hardware infrastructure for VCE 100.

The physical and/or virtual machines include a variety of applications (e.g., operating system, word processing, etc.). The physical and/or virtual machines may have the same installed applications or may have different installed applications or software. The installed software may be one or more software applications from one or more vendors.

Each virtual machine may include a guest operating system and a guest file system.

Moreover, the virtual machines may be logically grouped. That is, a subset of virtual machines may be grouped together in a container (e.g., VMware vApp™). For example, three different virtual machines may be implemented for a particular workload. As such, the three different virtual machines are logically grouped together to facilitate in supporting the workload. The virtual machines in the logical group may execute instructions alone and/or in combination (e.g., distributed) with one another. Also, the container of virtual machines and/or individual virtual machines may be controlled by a virtual management system. The virtualization infrastructure may also include a plurality of virtual datacenters. In general, a virtual datacenter is an abstract pool of resources (e.g., memory, CPU, storage). It is understood that a virtual data center is implemented on one or some combination of physical machines.

In various embodiments, computing system 110 may be a cloud environment, such as cloud environment 120. Computing system 110 may be located in an Internet connected datacenter or a private cloud computing center coupled with one or more public and/or private networks. Computing system 110, in one embodiment, typically couples with a virtual or physical entity in a computing environment through a network connection which may be a public network connection, private network connection, or some combination thereof. For example, a user may couple via an Internet connection with computing system 110 by accessing a web page or application presented by computing system 110 at a virtual or physical entity.

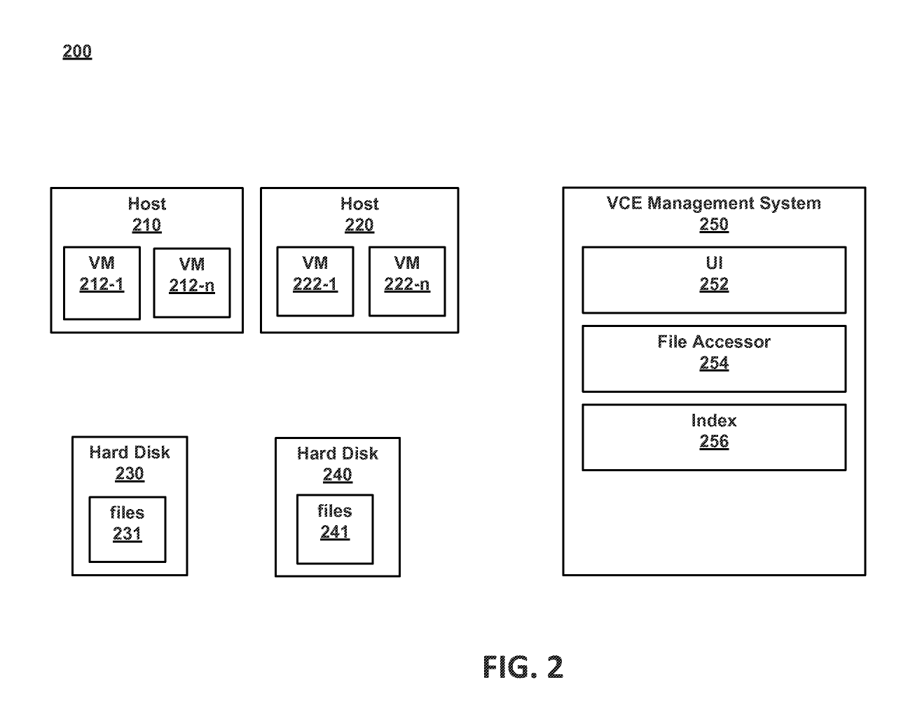

FIG. 2 depicts an embodiment of a block diagram of VCE 200. VCE 200 includes, among other things, host computing systems (e.g., host 210 and host 220), storage (e.g., hard disk 230 and hard disk 240) and VCE management system 250. It should be appreciated that components, as depicted in FIG. 2, may be located in computing system 110 or cloud environment 120.

A host computing system can be any computing system (e.g., server) that is capable of being a host for virtual machines. For example, host 210 hosts virtual machine 212-1 and virtual machine 212-n, and host 220 hosts virtual machine 222-1 and virtual machine 222-n. It should be appreciated that VCE 200 can include any number of host computing machines and each host may include any number of virtual machines.

A host includes a virtualization software that is installed on top of the hardware platform and supports a virtual machine execution space within which one or more virtual machines (VMs) may be concurrently instantiated and executed.

In some embodiments, the virtualization software may be a virtual machine monitor or a hypervisor (e.g., a VMware ESX™ hypervisor, a VMware ESXi™ hypervisor, etc.) For example, if hypervisor is a VMware ESX™ hypervisor, then virtual functionality of the host is considered a VMware ESX™ server.

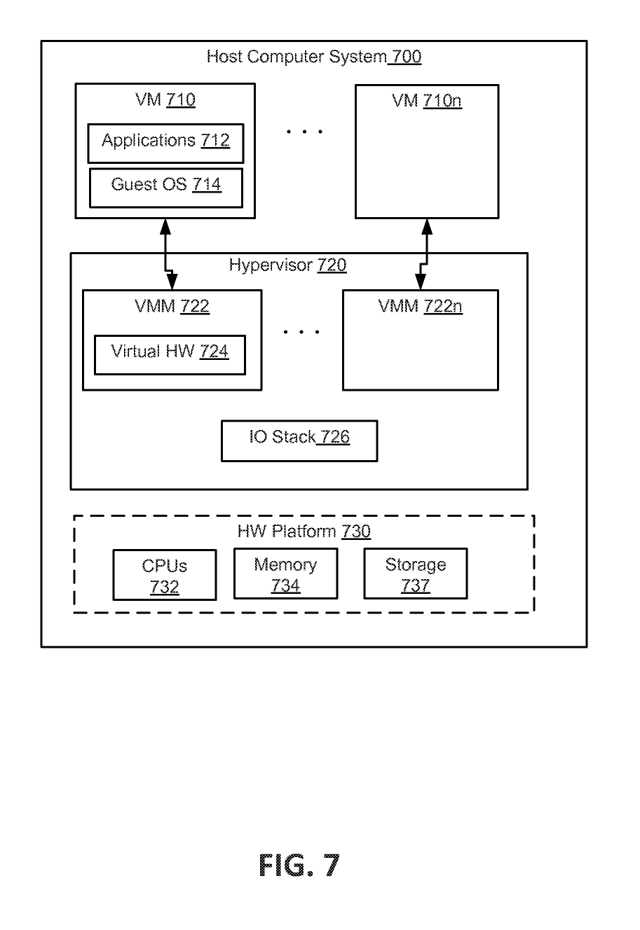

Additionally, a hypervisor or virtual machine monitor (VMM) is a piece of computer software, firmware or hardware that creates and runs virtual machines. A computer on which a hypervisor is running one or more virtual machines is defined as a host machine. Each virtual machine is called a guest machine. The hypervisor presents the guest operating systems with a virtual operating platform and manages the execution of the guest operating systems. Additional details regarding embodiments of structure and functionality of a host computer system are provided with respect to FIG. 7.

During use, the virtual machines perform various workloads. For example, the virtual machines perform the workloads based on executing various applications. The virtual machines can perform various workloads separately and/or in combination with one another.

The virtual machines may access resources such as hard disk 230 and/or hard disk 240 to access files (e.g., files 231 and files 241, respectively). Moreover, a user may store various files in the hard disks for subsequent use. Files can be any file that may be accessed and utilized by a user via a virtual machine.

Hard disk 230 and hard disk 231 can be, but are not, limited to, redundant array of independent disks (RAID), storage area network (SAN), etc. It should be appreciated that VCE 200 enables virtual storage such as virtual hard disks. Provisioning storage for a virtual infrastructure includes navigating several layers of abstraction. In one embodiment, a storage stack includes the layers of abstraction. A storage stack (e.g., an ESXi storage stack) can include, among other things, a server level (e.g., ESXi server level) for addressing and provision the storage, and a virtual machine level that enables determining how a virtual disk is portioned and addressed.

In one embodiment, the hard drives are first-class disks.

In some embodiments, files 231 and/or 241 may be in a Virtual Machine Disk (VMDK) format. In general, the VMDK format is a container for virtual hard disk drives to be used in virtual machines. VMDK files appear as standard disk drives to the guest operating systems of the virtual machines.

VCE management system 250 (e.g., VMware vCenter™) is configured to manage VCE 200. For example, VCE management system 250 enables a user (e.g., IT administrator) to monitor, troubleshoot, and/or manage various features and components of VCE 200 through user interface 252. For example, if a virtual machine is running poorly, performance characteristics and information of the virtual machine (e.g., resource usage, latency, workloads, alerts, alarms, etc.) may be displayed to facilitate the user in properly troubleshooting the virtual machine. It should be appreciated that VCE management system 250 may have access to any feature, functionality, and/or component of VCE 200 to effectively manage VCE 200.

VCE management system 250, among other things, presents the guest operating systems with a virtual operating platform and manages the execution of the guest operating systems. Additionally, VCE management system 250 controls and manages at least user interface 252 and file accessor 254, which is described in further detail below.

VCE management system 250 includes file accessor 254. File accessor 254 is configured to access one or more files (e.g., files 231 and 241) located in one or more hard disks via user interface 252. More specifically, file accessor 254 accesses files in hard disks (via user interface 252) while virtual machines associated with hard disks are not required to be powered on. The file accessor 254 may also access a hard disk or a virtual disk which is not attached/associated with a virtual machine.

In one embodiment, file accessor 254 accesses the files using a command-line disk mount tool (e.g., VMware™ DiskMount™). It is noted that, in general, “mounting” is the accessibility of files in a storage device through a file system. Accordingly, file accessor 254, for example, allows mounting to an unused virtual disk as a separate drive or partition without requiring to connect to the virtual disk from within a virtual machine.

Additionally, in some embodiments, file accessor 254 can mount specific volumes of a virtual disk if the virtual disk is partitioned. After a virtual disk is mounted, one can read from and write to the mounted virtual disk as if it were a separate file system with its own drive letter or mount point. For example, the disk could be scanned for viruses or transfer files between the host system and a powered off virtual machine.

In one embodiment, file accessor 254 is a back-end tool that is accessed and controlled by VCE management system 250 through user interface 252. That is, user input, associated with mounting a hard disk, provided at user interface 252 is mapped to the back-end file accessor 254. Additionally, output from back-end file accessor 254, in response to the user input, is then mapped as instructions specific to user interface 252 of VCE managements system 250. As a result, a user is able to access the functionality of file accessor 254 without the user required to provide command-line input directly to file accessor 254. In particular, the functionality of file accessor 254 is provided more efficiently and more user-friendly through user interface 252.

In various embodiments, VCE management system 250 may provide application programming interface (API) access to the virtual disk mount/indexing information. For example, user interface 252 utilizes the API for its functionality. That is, while UI 252 depicts access to the virtual disk mount/indexing information, the accessing is provided via scalable/automatable API functionality.

In one embodiment, user interface 252 is a web user interface. The graphical web user interface allows users to interact with the host machine through graphical icons and visual indicators, for example, via mouse control. Accordingly, a user is able to interact with files 231 and 241 through the web user interface integrated with the hypervisor without entering command lines.

Moreover, the user is able to view the files through the web client user interface without leaving the web client user interface.

It should be appreciated that a user can view the files on various user interface platforms. For example, user interface 252 employs a web client plug-in, an HTML bridge, Jquery library, Light java resources, etc.

It should be appreciated, that in some embodiments, programming level access is available at the management layer and the UI is not utilized.

In various embodiments, information related to the hard disk and/or associated files are obtained. For example, when a virtual disk is mounted, metadata related to the hard disk and/or files is obtained. Such metadata, can be, but is not limited to, disk name, file name, file size, last modified, patch levels, etc.

In one embodiment, the obtained information is a copy of the hard disk and/or files. For example, all of the files of the mounted hard disk are copied/mirrored.

In one embodiment, file accessor 254 periodically polls hard drives and/or files in VCE 200 for the information.

The information is stored by VCE Management System 250 and indexed in index 256.

In one embodiment, index 256 is text searchable. For example, a user may know the name of a desired file and simply enters the text of the file name to try to find the desired file. In one embodiment, the VCE management system allows accessing multiple virtual disks, at least two of which are attached to a virtual machine not being powered on or unattached to a virtual machine. The system allows a user to perform a search across the multiple virtual disks.

In another embodiment, index 256 is presented in a file system format. For example, index 256 is displayed on user interface 252 in a file system format and a user is able to browse through the displayed indexed files.

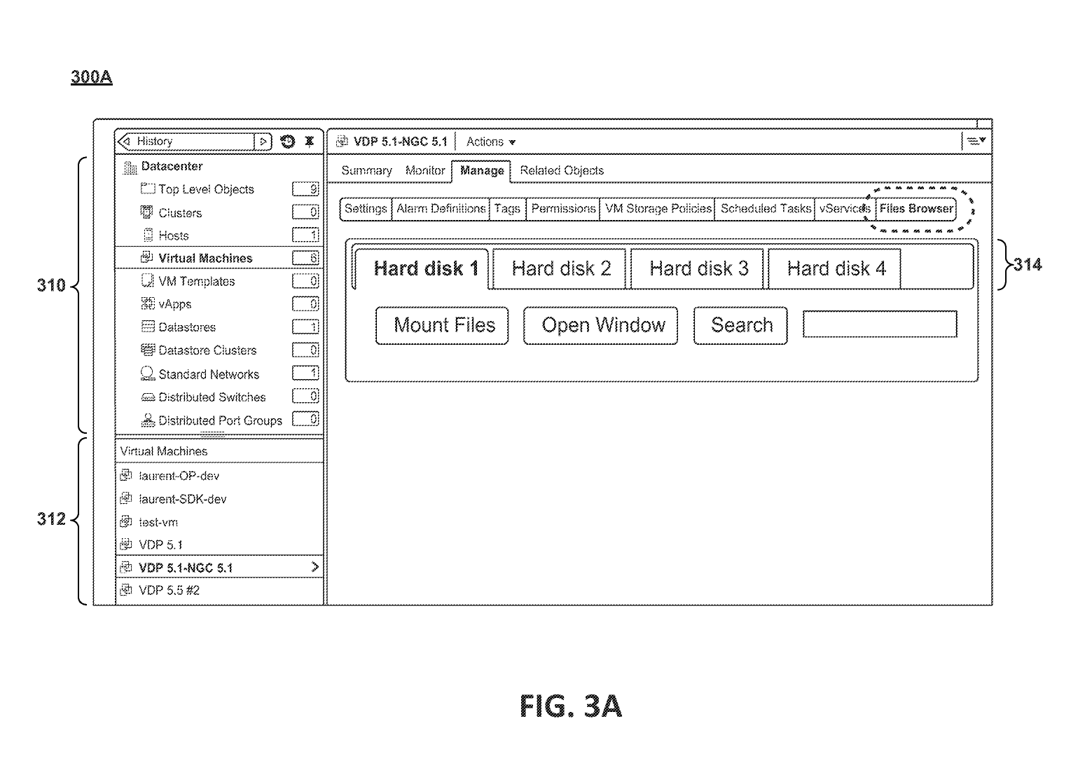

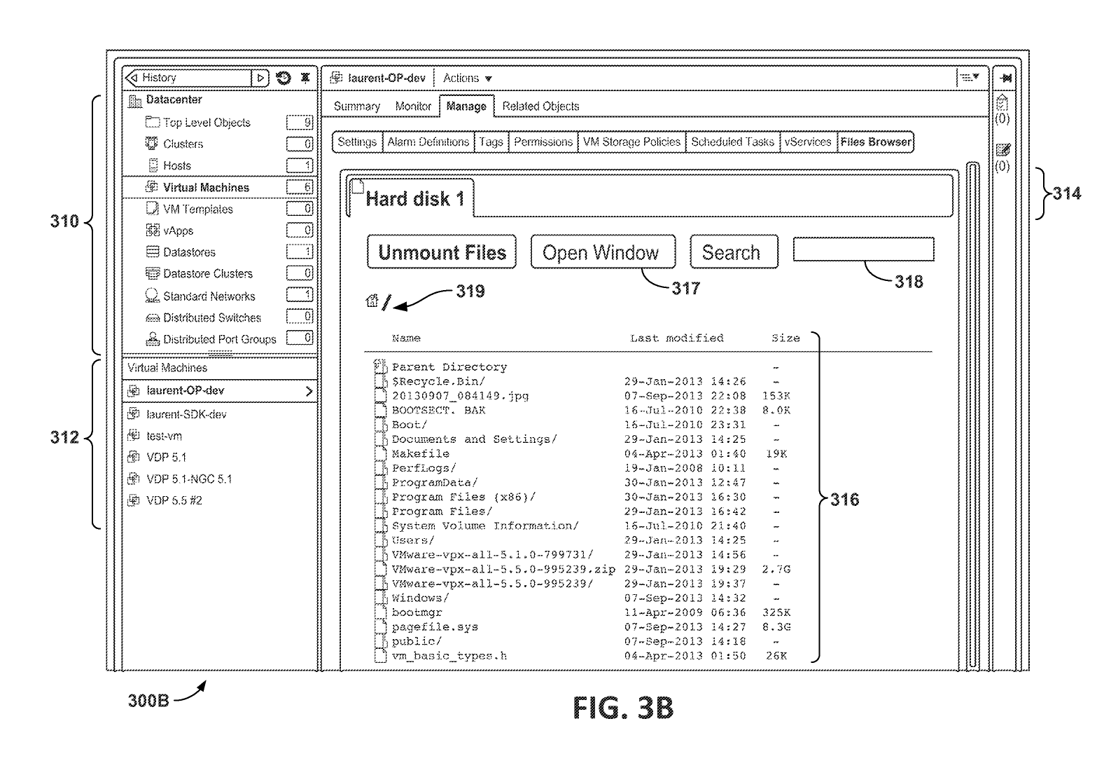

FIG. 3A depicts an embodiment of a screenshot 300A of user interface 252 displaying information obtained by file accessor 254. In such an embodiment, portion 310 includes a list of devices and resources associated with a data center in VCE 200. For example, portion 310 includes a selectable list that includes, clusters, hosts, virtual machines, etc.

Portion 312 includes a selectable list of virtual machines. For example, a user selects virtual machines in portion 310 and a list of the virtual machines is displayed in portion 312. In one embodiment, portion 312 includes an indicia (e.g., highlight) that indicates the state of the virtual machine (e.g., on or off).

Portion 314 depicts a tabbed list of hard disk drives in VCE 200. For example, a user selects a particular virtual machine in portion 312. In response, a list of hard disks associated with the selected virtual machine are displayed in portion 314.

In one embodiment, screenshot 300A is a screenshot of a web user interface. As such, a user is able to view files accessed by file accessor 254 via the web user interface. In particular, the user is able to view the files without out leaving the web user interface.

FIG. 3B depicts an embodiment of a screenshot 300B of user interface 252 displaying information obtained by file accessor 254. In such an embodiment, portion 316 displays various information associated with files in a hard disk. For example, “Hard Disk 1” is selected in portion 314. In response, list of folders and files in the selected hard disk are displayed in portion 316. The information is displayed in a file system format.

In one embodiment, portion 316 depicts the name, last modified, and size characteristics of folders and files found in a hard disk. It should be appreciated that any information associated with folders or files may be depicted.

Open Window button 317 is for displaying the same files list in a separate browser tab (e.g., for exploring files outside the constraints of the Web client).

Screenshot 300B depicts searching feature 318. For example, a user is interested in finding a .txt file. Accordingly, the user can search all .txt files or search by the name of the particular text file.

Additionally, a file listed in portion 316 may be selected and subsequently downloaded. It should be appreciated that user interface 252 may display text or image content in-place or prompt the user to download content that cannot be displayed.

Portion 319 depicts “crumbs” or the directory path of folders/files selected in portion 316. The directory path is interactive such that a user can select any parent folder in the directory and automatically jump to the selected parent folder.

In one embodiment, screenshot 300B is a screenshot of a web user interface. As such, a user is able to view files accessed by file accessor 254 via the web user interface. In particular, the user is able to view the files without out leaving the web user interface.

### Example Methods of Operation

The following discussion sets forth in detail the operation of some example methods of operation of embodiments. With reference to FIGS. 3, 4 and 5, flow diagrams 400, 500 and 600 illustrate example procedures used by various embodiments. Flow diagrams 400-600 include some procedures that, in various embodiments, are carried out by a processor under the control of computer-readable and computer-executable instructions. In this fashion, procedures described herein and in conjunction with flow diagrams 400, 500 and/or 600 are, or may be, implemented using a computer, in various embodiments. The computer-readable and computer-executable instructions can reside in any tangible computer readable storage media. Some non-limiting examples of tangible computer readable storage media include random access memory, read only memory, magnetic disks, solid state drives/“disks,” and optical disks, any or all of which may be employed with computer environments (e.g., computer system 110 and/or cloud environment 120). The computer-readable and computer-executable instructions, which reside on tangible computer readable storage media, are used to control or operate in conjunction with, for example, one or some combination of processors of the computer environments and/or cloud environment. It is appreciated that the processor(s) may be physical or virtual or some combination (it should also be appreciated that a virtual processor is implemented on physical hardware). Although specific procedures are disclosed in flow diagrams 400, 500 and 600 such procedures are examples. That is, embodiments are well suited to performing various other procedures or variations of the procedures recited in flow diagrams 400, 500 and 600. Likewise, in some embodiments, the procedures in flow diagrams 400, 500 and 600 may be performed in an order different than presented and/or not all of the procedures described in one or more of these flow diagrams may be performed. It is further appreciated that procedures described in flow diagrams 400, 500 and 600 may be implemented in hardware, or a combination of hardware with firmware and/or software.

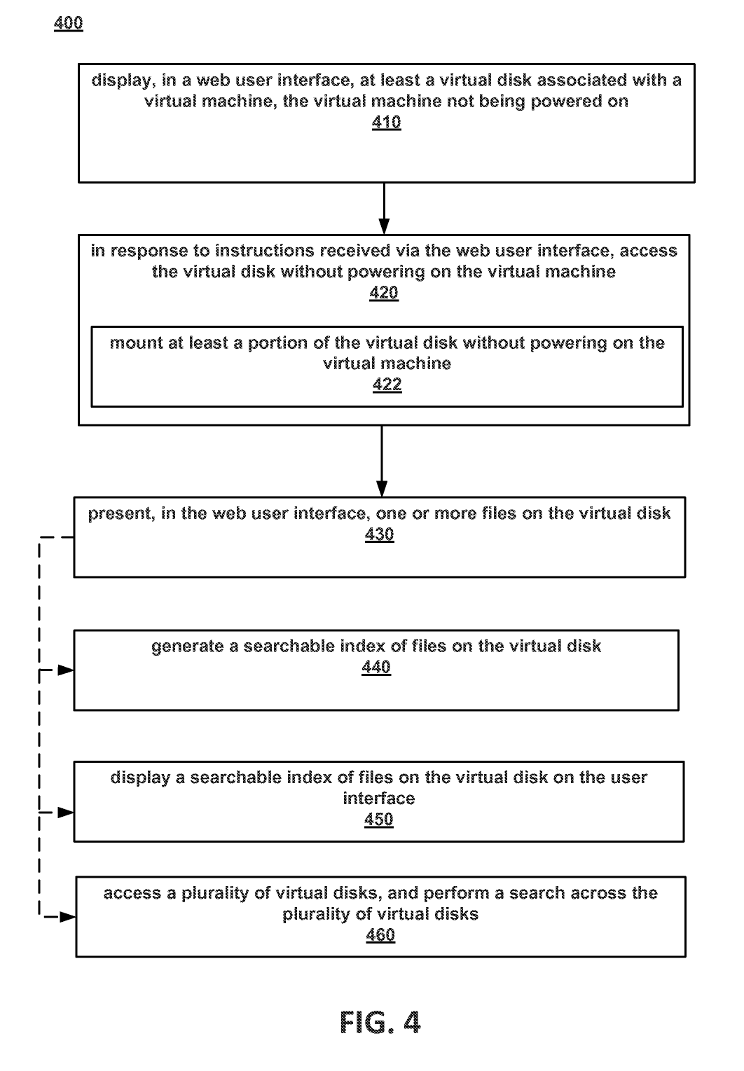

FIG. 4 depicts a process flow diagram 400 for accessing a file located in a virtual computing environment, according to various embodiments.

At 410, a virtual disk associated with a virtual machine is displayed in a web user interface, wherein the virtual machine is not powered on. For example, file accessor 254 accesses virtual disks (e.g., hard disk 230 and 240) in VCE 200 in response to user input provided through user interface 252 (e.g., a web user interface) of VCE management system 250 such that the virtual disk is displayed on the user interface. More specifically, screenshot 300A is a screenshot of a web user interface, and the web user interface includes a list of virtual disks, for example, in portion 314.

At 420, in response to instructions received via the web user interface, the virtual disk is accessed without powering on the virtual machine. For example, file accessor 254 accesses hard disk 230 via user instructions through the web user interface (e.g., user interface 252) without powering on the virtual machine associated with the virtual disk.

At 422, in one embodiment, at least a portion of the virtual disk is mounted without powering on the virtual machine. For example, file accessor 254 allows accessibility to hard disk 240. As such, accessibility of the files in the hard disk are available through a file system without the need to power on the virtual machine associated with hard disk 240.

At 430, one or more files on the virtual disk are presented in the web user interface. For example, files 231 of hard disk 230 are presented in user interface 252. More specifically, files 231 are displayed in portion 316 of screenshot 300B.

At 440, a searchable index of files on the virtual disk is generated. For example, index 256 is generated which contains obtained information from the accessed files.

At 450, a searchable index of files on the virtual disk is displayed on the user interface. For example, index 256 is displayed in user interface 252 in at least portion 316 of screenshot 300B.

At 460, a plurality of virtual disks are accessed, and a search across the plurality of virtual disks is performed. For example, files 231 in hard disk 230 and files 241 in hard disk 240 are accessed for subsequent searching.

It is noted that any of the procedures, stated above, regarding flow diagram 400 may be implemented in hardware, or a combination of hardware with firmware and/or software. For example, any of the procedures are implemented by a processor(s) of a cloud environment and/or a computing environment.

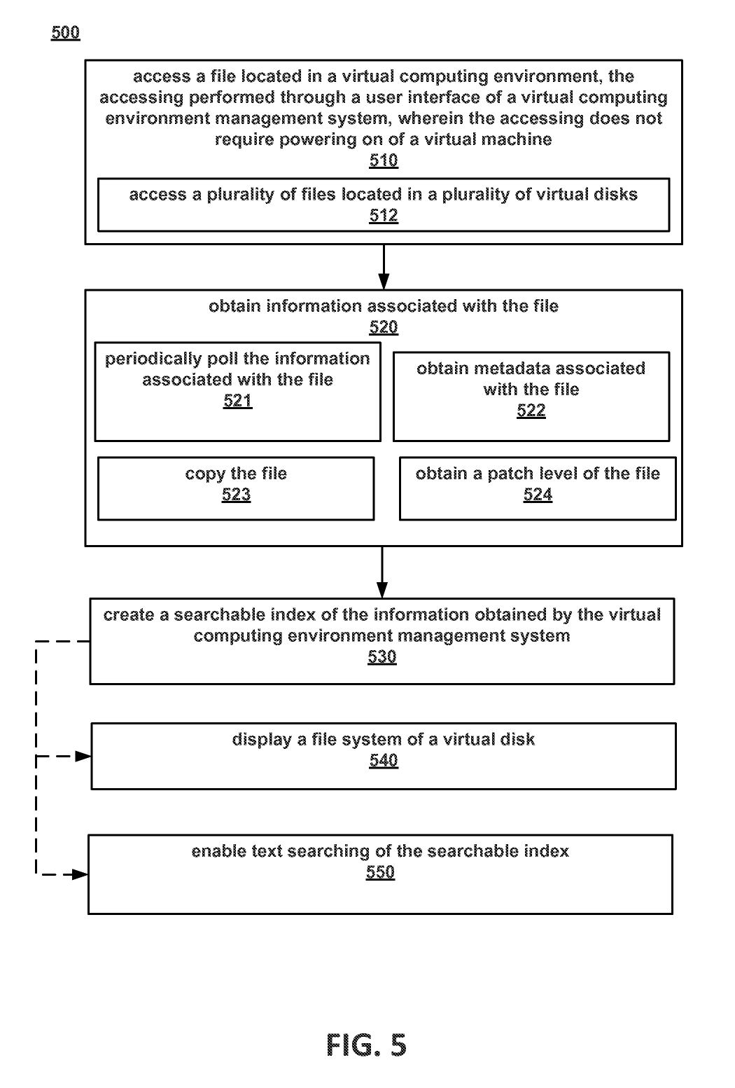

FIG. 5 depicts a process flow diagram 500 for accessing a file located in a virtual computing environment, according to various embodiments.

At 510, a file located in a virtual computing environment is accessed, the accessing performed through a user interface of a virtual computing environment management system, wherein the accessing does not require powering on of a virtual machine.

For example, file accessor 254 accesses files (e.g., files 231) in VCE 200 in response to user input provided through user interface 252 of VCE management system 250. More specifically, file accessor 254 mounts on to, for example, hard disk 230 such that file accessor is able to access files 231 without the need for associated virtual machines (e.g., virtual machine 212-1 and 212-n) to be powered on.

At 512, a plurality of files located in a plurality of disks are accessed. For example, files 231 in disk 230 and files 241 in disk 240 are accessed by file accessor 254 such that any associated virtual machines are not required to be powered on during the accessing.

At 520, information associate with the file is obtained.

At 521, in one embodiment, the information associated with the file is periodically polled. For example, file accessor 254 periodically polls VCE 200 (e.g., hourly, daily, etc.) to obtain information associated with files within VCE 200.

At 522, in another embodiment, metadata associated with the file is obtained. For example, name, size of file, and the like of the file is obtained.

At 523, in a further embodiment, the file is copied. For example, the entire file is copied.

At 524, in one embodiment, a patch level of the file is obtained. For example, a file has been deemed to have needed a patch. As such, a patch level of the file is obtained.

At 530, a searchable index of the information is created by the virtual computing environment management system. For example, VCE management system 250 generates searchable index 256. In such an example, a user may be interested in finding a particular .doc or .jpg file. As such, the user is able to search through index 256 to find the desired files.

At 540, a file system of the virtual disk is displayed. For example, the file system of virtual disk 230 is provided in index 256 based on the information of the files obtained by file accessor 254. Accordingly, the file system of virtual disk is able to be displayed on user interface 252 based on index 256.

At 550, text searching of the searchable index is enabled. For example, user interface 252 provides searching feature 318 that enables a user to enter text to search for a particular file or files.

It is noted that any of the procedures, stated above, regarding flow diagram 500 may be implemented in hardware, or a combination of hardware with firmware and/or software. For example, any of the procedures are implemented by a processor(s) of a cloud environment and/or a computing environment.

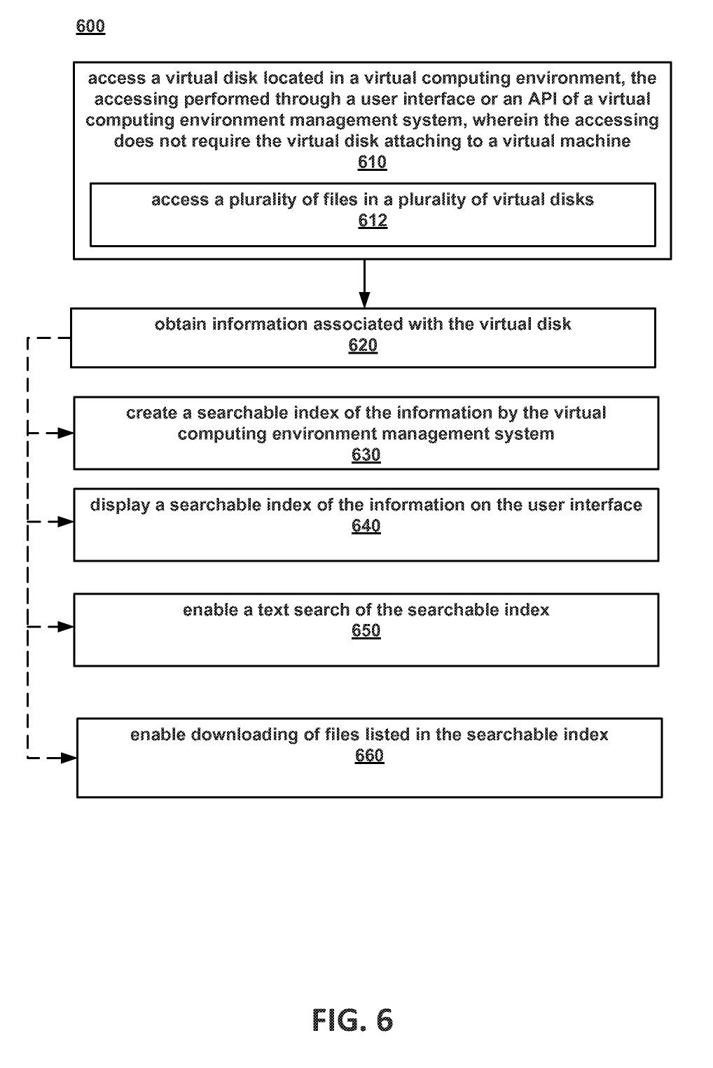

FIG. 6 depicts a process flow diagram 600 for accessing a file located in a virtual computing environment, according to various embodiments.

At 610, a virtual disk located in a virtual computing environment is accessed, the accessing performed through a user interface or an API of a virtual computing environment management system, wherein the accessing does not require the virtual disk attaching to a virtual machine.

For example, file accessor 254 mounts to disk 230 and accesses files 231 in disk 230 in response to user input at user interface 252. Additionally, file accessor 254 is able to access files 231 without the need for associated virtual machines (e.g., virtual machine 212-1) to be powered on. Additionally, the virtual disk may be accessed through an API.

At 612, in one embodiment, a plurality of files in a plurality of virtual disks are accessed. For example, file accessor 254 mounts to disk 230 and disk 240 to access files in the disks.

At 620, information associated with the virtual disk is obtained. For example, metadata associated with accessed files are obtained.

At 630, a searchable index of the information is created by the virtual computing environment management system. For example, VCE management system 250 generates searchable index 256.

At 640, a searchable index of the information is displayed on the user interface. For example,

At 650, enable a text search of the searchable index. For example, at least some information of index 256 is displayed on user interface 252. In particular, a list of files in VCE 200 are displayed in portion 316 of FIG. 3B.

At 660, downloading of files listed in the searchable index is enabled. For example, a user may select one or files in portion 316 and subsequently download the selected files.

It is noted that any of the procedures, stated above, regarding flow diagram 600 may be implemented in hardware, or a combination of hardware with firmware and/or software. For example, any of the procedures are implemented by a processor(s) of a cloud environment and/or a computing environment.

### Example Host Computer System

FIG. 7 is a schematic diagram that illustrates a virtualized computer system that is configured to carry out one or more embodiments of the present invention. The virtualized computer system is implemented in a host computer system 700 including hardware platform 730. In one embodiment, host computer system 700 is constructed on a conventional, typically server-class, hardware platform.

Hardware platform 730 includes one or more central processing units (CPUs) 732, system memory 734, and storage 736. Hardware platform 730 may also include one or more network interface controllers (NICs) that connect host computer system 700 to a network, and one or more host bus adapters (HBAs) that connect host computer system 700 to a persistent storage unit.

Hypervisor 720 is installed on top of hardware platform 730 and supports a virtual machine execution space within which one or more virtual machines (VMs) may be concurrently instantiated and executed. Each virtual machine implements a virtual hardware platform that supports the installation of a guest operating system (OS) which is capable of executing applications. For example, virtual hardware 724 for virtual machine 710 supports the installation of guest OS 714 which is capable of executing applications 712 within virtual machine 710.

Guest OS 714 may be any of the well-known commodity operating systems, and includes a native file system layer, for example, either an NTFS or an ext3FS type file system layer. IOs issued by guest OS 714 through the native file system layer appear to guest OS 714 as being routed to one or more virtual disks provisioned for virtual machine 710 for final execution, but such IOs are, in reality, are reprocessed by IO stack 726 of hypervisor 720 and the reprocessed IOs are issued, for example, through an HBA to a storage system.

Virtual machine monitor (VMM) 722 and 722n may be considered separate virtualization components between the virtual machines and hypervisor 720 (which, in such a conception, may itself be considered a virtualization “kernel” component) since there exists a separate VMM for each instantiated VM. Alternatively, each VMM may be considered to be a component of its corresponding virtual machine since such VMM includes the hardware emulation components for the virtual machine. It should also be recognized that the techniques described herein are also applicable to hosted virtualized computer systems. Furthermore, although benefits that are achieved may be different, the techniques described herein may be applied to certain non-virtualized computer systems.

The various embodiments described herein may be practiced with other computer system configurations including hand-held devices, microprocessor systems, microprocessor-based or programmable consumer electronics, minicomputers, mainframe computers, and the like.

One or more embodiments of the present invention may be implemented as one or more computer programs or as one or more computer program modules embodied in one or more computer readable media. The term computer readable medium refers to any data storage device that can store data which can thereafter be input to a computer system—computer readable media may be based on any existing or subsequently developed technology for embodying computer programs in a manner that enables them to be read by a computer. Examples of a computer readable medium include a hard drive, network attached storage (NAS), read-only memory, random-access memory (e.g., a flash memory device), a CD (Compact Discs)--CD-ROM, a CD-R, or a CD-RW, a DVD (Digital Versatile Disc), a magnetic tape, and other optical and non-optical data storage devices. The computer readable medium can also be distributed over a network coupled computer system so that the computer readable code is stored and executed in a distributed fashion.

Although one or more embodiments of the present invention have been described in some detail for clarity of understanding, it will be apparent that certain changes and modifications may be made within the scope of the claims. Accordingly, the described embodiments are to be considered as illustrative and not restrictive, and the scope of the claims is not to be limited to details given herein, but may be modified within the scope and equivalents of the claims. In the claims, elements and/or steps do not imply any particular order of operation, unless explicitly stated in the claims.

Virtualization systems in accordance with the various embodiments may be implemented as hosted embodiments, non-hosted embodiments or as embodiments that tend to blur distinctions between the two, are all envisioned. Furthermore, various virtualization operations may be wholly or partially implemented in hardware. For example, a hardware implementation may employ a look-up table for modification of storage access requests to secure non-disk data.

Many variations, modifications, additions, and improvements are possible, regardless the degree of virtualization. The virtualization software can therefore include components of a host, console, or guest operating system that performs virtualization functions. Plural instances may be provided for components, operations or structures described herein as a single instance. Finally, boundaries between various components, operations and data stores are somewhat arbitrary, and particular operations are illustrated in the context of specific illustrative configurations. Other allocations of functionality are envisioned and may fall within the scope of the invention(s). In general, structures and functionality presented as separate components in exemplary configurations may be implemented as a combined structure or component. Similarly, structures and functionality presented as a single component may be implemented as separate components. These and other variations, modifications, additions, and improvements may fall within the scope of the appended claims(s).

1. A computer-implemented method for exploring files stored on a virtual disk associated with a virtual machine in a virtual computing environment, said computer-implemented method comprising:
displaying, in a web user interface, at least a virtual disk associated with a virtual machine, the virtual machine not being powered on;
in response to instructions received via the web user interface, accessing the virtual disk without powering on the virtual machine; and
presenting, in the web user interface, one or more files on the virtual disk.

2. The computer-implemented method of claim 1, wherein the virtual disk has a file system to organize one or more files stored on the virtual disk, wherein the process of presenting one or more files comprises presenting the file system in the web user interface.

3. The computer-implemented method of claim 1, wherein the process of accessing the virtual disk comprises:
mounting at least a portion of the virtual disk without powering on the virtual machine.

4. The computer-implemented method of claim 1, further comprising:
accessing a plurality of virtual disks; and
performing a search across the plurality of virtual disks.

5. The computer-implemented method of claim 1, wherein said virtual machine is associated with a virtual disk containing said file.

6. The computer-implemented method of claim 1, further comprising:
generating a searchable index of files on the virtual disk.

7. The computer-implemented method of claim 1, further comprising:
displaying a searchable index of files on the virtual disk on said user interface.

8. A computer-implemented method for accessing a file located in a virtual computing environment, said computer-implemented method comprising:
accessing a file located in a virtual computing environment, said accessing performed through a user interface of a virtual computing environment management system, wherein said accessing does not require powering on of a virtual machine;
obtaining information associated with said file; and
creating a searchable index of said information by said virtual computing environment management system.

9. The computer-implemented method of claim 8, wherein said accessing a file further comprises:
accessing a plurality of files located in a plurality of virtual disks.

10. The computer-implemented method of claim 8, wherein said file is in a read-only mode.

11. The computer-implemented method of claim 8, wherein said obtaining information associated with said file further comprises:
periodically polling said information associated with said file.

12. The computer-implemented method of claim 8, wherein said obtaining information associated with said file further comprises:
obtaining metadata associated with said file.

13. The computer-implemented method of claim 8, wherein said obtaining information associated with said file further comprises:
copying said file.

14. The computer-implemented method of claim 8, wherein said obtaining information associated with said file further comprises:
obtaining a patch level of said file.

15. The computer-implemented method of claim 8, further comprising:
displaying a file system of a virtual disk.

16. The computer-implemented method of claim 8, further comprising:
enabling text searching of said searchable index.

17. A non-transitory computer-readable storage medium having instructions embodied therein that when executed causes a computer system to perform a method for accessing a file located in a virtual computing environment, said method comprising:
accessing a virtual disk located in a virtual computing environment, said accessing performed through a user interface of a virtual computing environment management system or an application programming interface, wherein said accessing does not require said virtual disk attaching to a virtual machine; and
obtaining information associated with said virtual disk.

18. The non-transitory computer-readable storage medium of claim 17, wherein said accessing a virtual disk further comprises:
accessing a plurality of files in a plurality of virtual disks.

19. The non-transitory computer-readable storage medium of claim 17, further comprising:
creating a searchable index of said information by said virtual computing environment management system.

20. The non-transitory computer-readable storage medium of claim 17, further comprising:
displaying a searchable index of said information on said user interface.

21. The non-transitory computer-readable storage medium of claim 20, further comprising:
enabling a text search of said searchable index.

22. The non-transitory computer-readable storage medium of claim 20, further comprising:
enabling downloading of files listed in said searchable index.
